(19) United States
(12) Patent Application Publication
(10) Pub. No.: US 2005/0284543 A1
(43) Pub. Date: Dec. 29, 2005

(54) Pre-directing insert for a bi-directional exhausting handheld planer

(75) Inventor: William Edward Kaiser, Anderson, SC (US)

Correspondence Address: BRINKS HOFER GILSON & LIONE, P.O. BOX 10395, CHICAGO, IL, 60610, US

(73) Assignee: One World Technologies Limited

(21) Appl. No.: 10/875,909

(22) Filed: Jun. 23, 2004

(51) Int. Cl. B27C 1/00; B27G 19/00; B27G 21/00; B27M 1/08; B27C 9/00; B27L 11/00; B27C 1/10

(52) U.S. Cl. 144/373; 144/154.5; 144/114.1; 144/252.1; 30/475

(57) ABSTRACT

A bi-directional handheld planer is used to remove chips from a workpiece in order to make the surface planar. The handheld planer allows the user to choose between a pair of opposing exhaust ports from which the chips are to be expelled from the planer. Particular handheld planers have a normal direction of air flow that is transverse to the longitudinal direction of the planer. The bi-directional handheld planer provides for exhaustion of the chips through either of a pair of exhaust ports, and an insert can be disposed within the cutting chamber to pre-direct the chips toward one of the exhaust ports in order to prevent the clogging of the exhaust port which caused by the turbulence and constant contact of the chips being re-directed in the direction opposite the normal flow of air through the housing of the planer.

### BACKGROUND

The present invention relates to the field of handheld planers, and more particularly to bi-directional exhausting handheld planers.

Portable handheld planers are used to smooth uneven surfaces on workpieces by shaving raised portions from the workpiece until the surface is substantially smooth. The handheld planers utilize a high-speed rotary cutting tool having at least one blade that is configured to cut and remove small pieces of the workpiece (chips) until the smooth surface is achieved. The blades are located within the housing of the planer, and extend therefrom to contact the surface of the workpiece to be planed. The extent to which the blades extend beyond the housing can be adjusted to provide a deeper cut into the workpiece such that more of the workpiece is removed with each rotation of the cutting tool. As the small pieces of the workpiece are removed, they are generally expelled from the handheld planer through an exhaust port located on one side of the housing of the planer.

The cutting tool is rotated by a motor. The motor can be powered by an electric cord or by a removable battery pack. The motor includes a fan that produces a stream of air that is directed through the central portion of the housing. As the stream of air passes through the housing, the chips and the air stream are combined such that the air carries the chips out through an exhaust port.

The handheld planers provide an advantage over the stationary planers by allowing the user more freedom to move about the workpiece, work at a variety of angles, and greater accessibility to a workpiece. Handheld planers also provide for bi-directional exhaustion of the chips removed from the workpiece such that the user is provided with the option to choose from which exhaust port the chips are to be expelled. The advantage of the bi-directional exhausting of the chips allows the user to hold the planer in either hand when working so as to further increase the portability of the planer. However, bi-directional planers, in which the air stream from the motor flowing transverse to the longitudinal axis of the planer through the housing, often have problems with the chips clogging the exhaust port that is opposite the direction of the normal flow of air. There exists a need for an improved bidirectional exhausting planer that eliminates or substantially reduces the likelihood of clogging of the exhaust port while the user is working.

### BRIEF SUMMARY OF THE INVENTION

One aspect of the present invention provides an embodiment of a handheld planer that allows for bi-directional exhaustion of chips removed from a workpiece so that the user is allowed ambidextrous operation of the planer. One embodiment of such a planer includes a housing that can have a pair of exhaust ports from which the removed chips are expelled. The planer also includes a motor that is operatively connected to a rotatable fan and cutting tool. The cutting tool is located within the cutting chamber within the housing and as the cutting tool rotates chips are removed from the workpiece. An insert can also be located within the cutting chamber so that as the chips are removed by the cutting tool, the insert pre-directs the chips toward one of the exhaust ports. The planer can also include an adjustable flap that can be selectively positioned by the user so the user can choose from which exhaust port the chips are to be expelled.

In another embodiment, the insert located within the cutting chamber has a ribbed, vaned, or undulating surface having a plurality of raised, angled ribs or protrusions in which each raised rib is connected to an adjacent rib by a sloped surface.

Another aspect of the present invention provides a method for planing a workpiece using a bi-directional exhausting handheld planer. The method includes providing a housing that has a pair of exhaust ports and a cutting chamber that is located within the housing. The method also includes rotatably mounting a cutting tool within the cutting chamber and attaching a pre-directing insert within the cutting chamber so that the chips are pre-directed toward one of the exhaust ports. Finally, the method includes selecting the port from which the chips are to be exhausted by positioning a flap in either a first or second position.

Advantages of the present invention will become more apparent to those skilled in the art from the following description of the preferred embodiments of the invention which have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a top perspective view of one embodiment of a bidirectional exhausting handheld planer;

FIG. 2 is a top perspective view of the planer of FIG. 1 in which a portion of the housing is removed; and

FIG. 3 is a sectional view of the planer of FIG. 1;

FIG. 4A is a sectional view of the planer of FIG. 3 along the line 4-4 with a flap in a first position;

FIG. 4B is a sectional view of the planer of FIG. 3 along the line 4-4 with a flap in a second position;

FIG. 5A is a bottom sectional view of the planer of FIG. 3 along the line 5-5 with a flap in a first position;

FIG. 5B is a bottom sectional view of the planer of FIG. 3 along the line 5-5 with a flap in a second position;

FIG. 6 is a front view of the pre-directing insert of the present invention; and

FIG. 7 is a perspective view of the insert of FIG. 6.

### DETAILED DESCRIPTION

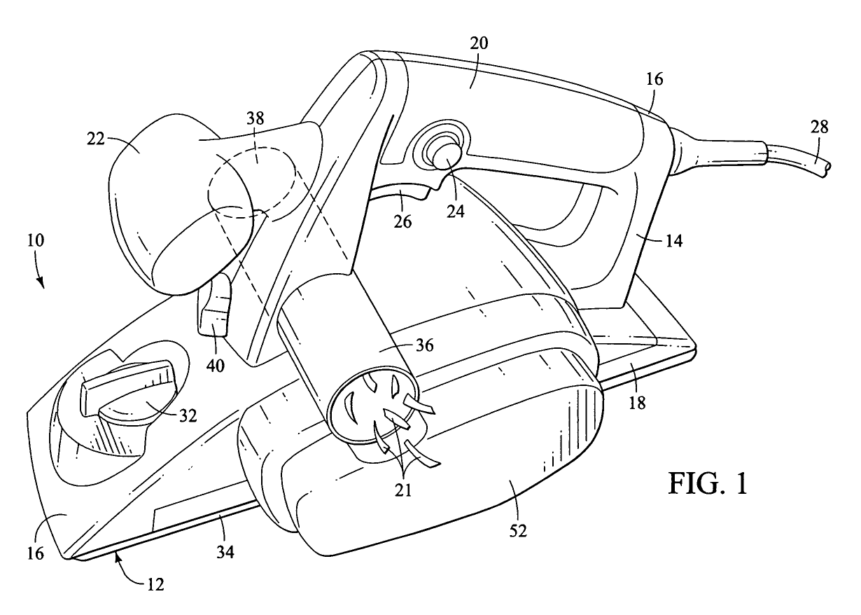

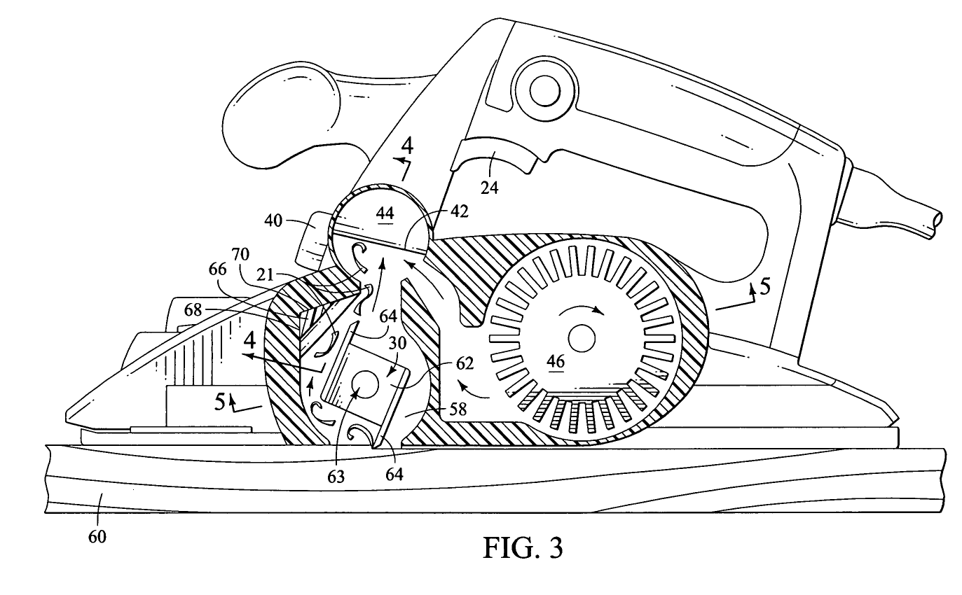

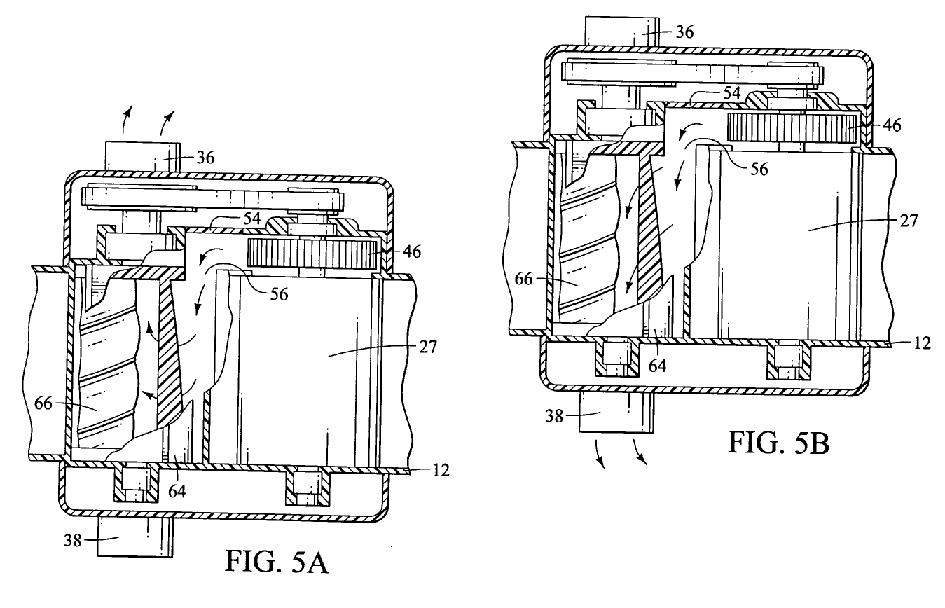

FIG. 1 is a top perspective view of one embodiment of a bidirectional exhausting handheld planer 10. The planer 10 includes a structural housing 12 having a first portion 14, a second portion 16, and a third portion 18 wherein the first and second portions 14, 16 divide the handle portion of the housing 12 into two distinct lateral halves, as shown in FIG. 3 with the first portion 14 removed, and the third portion 18 is disposed vertically below the first and second portions 14, 16. The planer 10 includes a rear handle 20 and a forward handle 22. The rear handle 20 is oriented in the longitudinal direction of the planer 10. In this embodiment, the forward handle 22 is oriented in the transverse direction of the planer 10 and is disposed longitudinally forward and vertically below the rear handle 20. The rear handle 20 includes a safety button 24 and a trigger 26 that is used to activate the motor 27 (FIGS. 5A-B).

Both handles 20, 22 allow the user to control the movement and direction of the planer 10. By grasping the rear handle 20 and the forward handle 22, the user can maneuver the planer 10 into areas that cannot be readily accessed using stationary tabletop planers. The electrical cord 28 provides electrical power to a motor 27 which, in turn, drives a cutting tool 30 (FIG. 3). It should be understood by one skilled in the art that the supply of power to the planer can be provided by an electrical cord, battery, or any other energy source sufficient to power the motor.

An adjustment knob 32 is located near the front end of the second portion 16 of the housing 12 for adjusting the height of the cutting tool 30 with respect to the workpiece 60 (FIG. 3). A planar engagement surface 34 is formed on the bottom of the planer 10 that is slidable along the surface of the workpiece being planed.

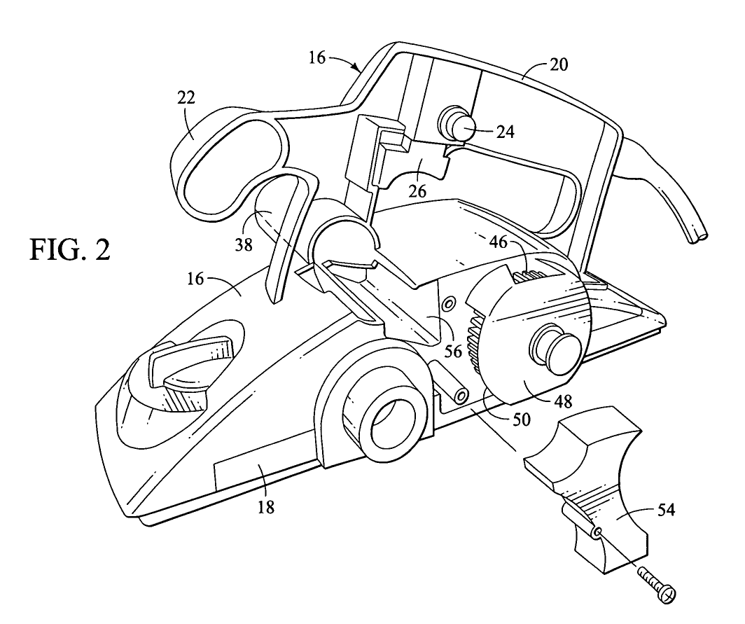

The first portion 14 of the housing 12 includes a first exhaust port 36 protruding laterally from the housing 12 in a transverse direction with respect to the length of the planer 10 (i.e., transverse to the longitudinal direction of the planer). The second portion 16 of the housing 12 includes a second exhaust port 38 (shown in hidden lines) extending laterally from the housing 12 in the opposite direction of the first exhaust port 36, as illustrated in FIG. 1 and shown in FIG. 2 in which the first portion 14 is removed. The exhaust ports 36, 38 are preferably disposed vertically below the forward handle 22. The two exhaust ports 36, 38 provide the planer 10 with bi-directional exhaustion of loose chips 21 from a workpiece.

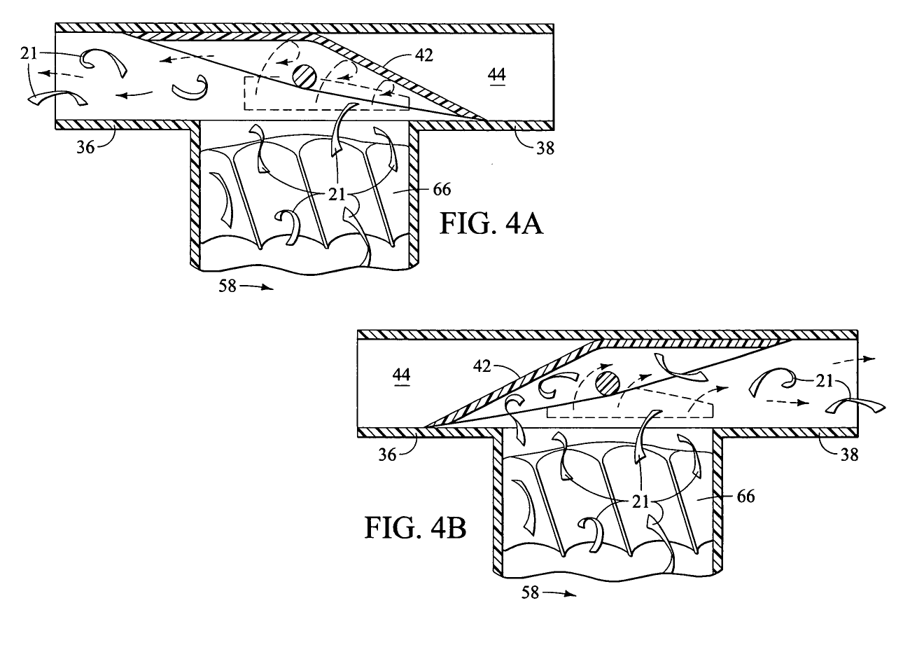

A switch 40 is disposed centrally between the opposing exhaust ports 36, 38. The switch 40 operates a flap 42 (FIGS. 4A-4B) located within the passageway 44 (FIG. 3) created by the opposing exhaust ports 36, 38. The switch 40 is moveable between a first position and a second position. When the switch 40 is located in the first position the chips 21 are exhausted from the first exhaust port 36 (FIG. 4A). When the switch 40 is located in the second position the chips 21 are exhausted from the second exhaust port 36 (FIG. 4B). The operation of the switch 40 and flap 42 will be described in more detail below.

Because the chips 21 can be expelled through either of the two exhaust ports 36, 38 and because the pair of handles 20, 22 are centrally located, the user can operate the planer 10 from either side. In addition, because the chips 21 can be selectively exhausted from either port 36, 38, the chips 21 can be expelled on the side of the planer 10 opposite the operator. In other words, the planer provides ambidextrous operation.

A fan cover 52, as illustrated in FIG. 1, extends in the lateral direction from the housing 12, and is designed to allow external air to enter the area between the fan cover 52 and the housing 12 through a plurality of vents (not shown) at the motor intake on the opposite side of the planer 10. The fan cover 52 is also designed to provide protection to a fan 46 (FIG. 2), which is operatively connected to the motor 27 (FIGS. 5A-B). The fan 46 is further shielded from loose chips by a protective cover 48 having at least one outlet 50 formed therein to allow the air flow generated by the fan 46 to be directed toward the passageway 44.

FIG. 2 illustrates a cutaway view of the planer 10 showing the first portion 14 of the housing 12 as well as the fan cover 52 removed, thus exposing the fan 46 and the protective cover 48. An air flow guide 54 is disposed between the fan cover 52 and the housing 12, and is illustrated in the exploded view of FIG. 2. The fan 42 is powered by a motor 27 and is configured to produce a stream of air that flows into the housing 12 to assist in exhausting the loose chips 21 from a workpiece through either the first or second exhaust port 36, 38. In operation, as the fan 46 rotates, the stream of air passes through an outlet 50 in the protective cover 48 and into the guide 54 which then directs the stream of air into the housing 12 by way of the inlet 56. Thus, as the stream of air enters the housing 12, the preferred direction of the air flow in the illustrated embodiment of a planer is transverse to the longitudinal direction of the planer 10 and is directed naturally through the passageway 44 toward the second exhaust port 38.

The motor 27 of the planer of the illustrated embodiment is disposed within the housing and is operatively connected to the fan located externally of the housing in which the preferred direction of air flow from the fan passes in a transverse manner through the housing toward the exhaust port on the side of the housing opposite the side to which the fan extends. In an alternative embodiment, the fan can be mounted in a likewise manner on the opposing side of the housing such that the normal flow of air through the housing is in the direction opposite that of the illustrated embodiment. In a further alternative embodiment, the fan can be disposed within the housing such that the normal flow of air is generally parallel to the longitudinal direction of the planer. It should be understood by one skilled in the art that the flow of air through the housing can be any direction sufficient to guide and carry the removed chips through an exhaust port.

As shown in FIG. 3, a cutting chamber 58 is located within the housing 12 longitudinally forward of the fan 46. The cutting chamber 58 is a generally cylindrical opening in which the cutting tool 30 is rotatably mounted. The cutting chamber 58 and the cutting tool 30 are oriented in a transverse direction with respect to the longitudinal direction of the planer 10. The cutting chamber 58 is configured to house the cutting tool 30 as well as contain the chips 21 as they are removed from a workpiece 60, and further to guide the loose chips 21 toward the passageway 44 where they can be expelled from an exhaust port 36, 38. The loose chips 21 and the stream of air from the fan 46 are not combined until they both reach the passageway 44, as illustrated in FIG. 3.

The cutting tool 30 includes a block 62 having a central bore 63 through the longitudinal center of the block 62 in order to allow a rotatable pin to be passed therethrough. The pin is rotatably mounted to the housing at each distal end by a bearing element (not shown). A motor 27 is operatively connected to the trigger 26 such that the actuation of the trigger activates the motor 27 that, in turn, drives the rotation of the fan 46 and the cutting tool 30 so that a pair of blades 64 are rotated simultaneously with the block 62. The blades 64 are attached to opposing surfaces of the block 62 in a manner such that each blade 64 extends beyond the edge of the surface of the block 62 to which it is mounted. The blades 64 extend beyond their respective edge of the block 62 in opposing directions relative to the block 62 so that each blade 64 contacts the workpiece 60 one time for each complete rotation of the block 62. Each time a blade 64 contacts the surface of the workpiece 60 a chip 21 is removed from the workpiece 60 until the surface of the workpiece 60 is planar.

As the loose chips 21 are removed from the workpiece 60, the rotation of the cutting tool 30 forces the chips 21 into the cutting chamber 58 away from the workpiece 60 and toward the passageway 44, as illustrated in FIG. 3. Once the chips 21 enter the passageway 44, the stream of air from the fan 46 combines with the chips 21 to guide the chips through one of the selected opposing exhaust ports 36, 38. The flap 42, only a portion of which is illustrated in FIG. 3, is disposed centrally within the passageway 44 and provides directional guidance to the loose chips 21 and the air as they exit from the user-selected exhaust port.

The flap 42, illustrated in FIGS. 4A-4B, is actuated by the switch 40 located on the outer surface of the housing 12. The flap 42 has a first position, illustrated in FIG. 4A, corresponding to the first position of the switch 42 and a second position, illustrated in FIG. 4B, corresponding to the second position of the switch 42. In the first position, the flap 42 is configured to direct the air flow and the loose chips 21 out through the first exhaust port 36. In the second position, the flap 42 is configured to direct the air flow and the loose chips 21 out through the second exhaust port 38. Rotation of the switch 42 actuates the flap 42 between the first and second positions. The shape of the flap 42 is slightly curved in which the apex of the curved portion of the flap 42 is located toward the upper portion of the passageway 44, and the opposing ends of the flap 42 extend downward. When the flap 42 is in the first position, one distal end of the flap 42 is located adjacent to the top portion of the passageway 44 and the opposing distal end of the flap 42 is located adjacent to the bottom portion of the passageway 44 such that the surface of the flap 42 facing the cutting chamber 58 provides a slight curved surface by which the loose chips 21 are deflected toward the first exhaust port 36. When the flap 42 is in the second position, the orientation of the distal ends of flap 42 are reversed such that the curved surface of the flap 42 directed toward the cutting chamber 58 deflects the loose chips 21 toward the second exhaust port 38.

FIGS. 5A-5B illustrate the flow of air through the housing 12 when the flap 42 is in the first and second positions, respectively. As previously discussed, the preferred direction of air flow in the illustrated embodiment of a planer begins at the fan 46 and exits the second exhaust port 38, as shown in FIGS. 4B and 5B. Thus, when the flap 42 is in the second position, the fan 46 directs air toward the guide 54 into the inlet 56 of the housing 12 to the passageway 44 where the flap 42 directs the air and loose chips 21 out the second exhaust port 38. There is very little impedence of air flow between when the air enters the housing 12 and when it exits the second exhaust port 38. In order to change the direction of exhaustion of the loose chips 21, the flap 42 is actuated to the first position such that the chips 21 are expelled from the first exhaust port 36. When the flap 42 is in the first position, the fan 46 directs air toward the guide 54 into the inlet 56 of the housing 12 to the passageway 44 where the flap 42 reverses the flow of air such that the air and chips 21 are expelled from the first exhaust port 36, as shown in FIGS. 4A and 5A. It should be understood by one skilled in the art that in an alternative embodiment of the planer in which the fan is mounted on the opposite side of the housing the preferred direction of the air stream and exhaustion of the chips would be in the transverse direction through the housing such that the chips would be expelled from the first exhaust port.

When the flap 42 is in the first position of one embodiment of a planer without a pre-directing insert, the air flow and loose chips 21 must reverse direction in order to be expelled from the first exhaust port 36, turbulence is created as a result of the constant collision between the loose chips 21 as the direction of the air flow is reversed. Turbulence caused by the constant collision of the chips and re-directing the air flow such that it exits the housing 12 in the opposite direction from which it entered may reduce the efficiency by which the chips 21 are expelled from the planer 10. This turbulence is remedied by a pre-directing insert 66 disposed within the cutting chamber 58. The turbulence is generally not present when the flap 42 is in the second position because the direction of the air flow is only slightly altered as it enters the housing 12 and the passageway 44 such that the air flows freely in the transverse direction through the housing 12 and combines with the chips 21, and the flow of air and chips are thus easily expelled from the second exhaust port 38.

The pre-directing insert 66, as illustrated in FIGS. 4A-7, is configured to pre-direct or cause the chips 21 to be directed toward the first exhaust port 36 prior to being directed toward a selected port by the flap 42. This pre-directing of the chips 21 helps to reduce or eliminate any potential clogging of the port 36 when flap 42 is in the first position. The insert 66 is located near the upper portion of the cutting chamber 58 such that as the chips 21 are removed from the workpiece 60 they contact the insert 66, as shown in FIG. 3, and are pre-directed within the cutting chamber 58 in the direction of the first exhaust port 36, as shown in FIGS. 4A-4B. The insert 66 is made of a thermoplastic, and preferably acrylonitrile-butadiene styrene (ABS), but can also be made of steel, aluminum, wood, or the like. It should be understood by one skilled in the art that the insert can be made of any material that can sufficiently withstand the constant collision resulting from the chips contacting the ribbed, or vaned surface of the pre-directing insert while the planer is in use.

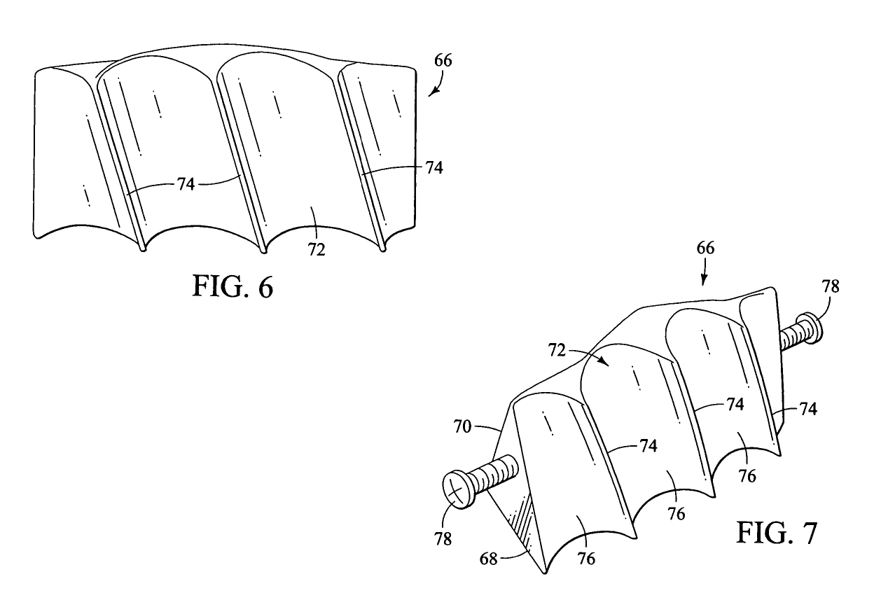

The insert 66 has a generally triangular cross-section having a pair of surfaces 68, 70 and a ribbed surface 72, as shown in FIGS. 6-7. The ribbed surface 72 is configured in a manner such that the ribbed surface 72 has a plurality of peaks and valleys, wherein the peaks are defined by a plurality of ribs 74, or vanes, and the valleys are defined by sloped surfaces 76 that couple adjacent ribs 74. The ribbed surface 72 has a plurality of ribs 74, or vanes, that are raised and extend in an outward direction. The cross-section of the sloped surfaces 76 is preferably generally parabolic curve extending between each rib 74. It should be understood by one skilled in the art that the cross-section of the sloped surfaces can have any shaped curve sufficient to direct the chips 21 toward one of the exhaust ports. Furthermore, the ribs 74 can be oriented at an angle with respect to the longitudinal direction of the insert 66. The angle at which the ribs 74 are oriented can vary between fifteen (15) degrees and eighty-five (85) degrees from horizontal, but the ribs 74 are preferably oriented at about sixty-seven (67) degrees from horizontal. It should be understood by one skilled in the art that the ribs can be oriented at any angle sufficient to provide directional guidance to the chips in the direction of one of the exhaust ports 36, 38 so that the chips are pre-directed prior to being selectively directed by the flap 42.

The insert 66 is secured within the cutting chamber 58 by a pair of screws 78 that are inserted through the housing 12 and into the side surfaces 78 of the insert 66. The insert 66 is disposed within the cutting chamber 58 such that the length of the insert is oriented in a transverse manner relative to the longitudinal direction of the planer 10 and parallel to the length of the cutting chamber 58, as illustrated in FIGS. 4A-5B. The surfaces 68, 70 of the insert 66 are located immediately adjacent corresponding surfaces within the cutting chamber 58 such that the ribbed surface 72 is directed toward the cutting tool 30. The ribbed surface 72 is oriented in a manner in which the ribs 74 are directed toward the first exhaust port 36 as the ribs extend away from the cutting tool 30 toward the passageway 44. It should be understood by one skilled in the art that in a bi-directional exhausting handheld planer, the ribs should be directed toward the exhaust port that tends to become clogged.

In operation, as the loose chips 21 are removed from the workpiece 60 and are directed toward the passageway 44, the loose chips 21 contact the insert 66 in a manner in which the angled ribs 74 pre-direct the chips 21 toward the first exhaust port 36. Thus, when the user selects the flap 42 to be in the first position such that the chips 21 are expelled from the first exhaust port 36, the loose chips 21 are already pre-directed toward the first exhaust port 36, and the turbulence that was caused by the impedance of the chips 21 with each other as they were re-directed is reduced or eliminated. Such a reduction or elimination of turbulence among the loose chips 21 during the re-direction of the chips with the aid of the re-directed air flow reduces or eliminates clogging of the first exhaust port 36, as shown in FIG. 4A.

When the user selects the flap 42 to be in the second position such that the chips 21 are expelled from the second exhaust port 38, the air flow through the housing 12 and passageway 44 is much more powerful than when the flap is in the first position because the air is not re-directed in the opposite direction. Hence, the additional pressure of the air flow through the housing 12 and passageway 44 easily combines with the pre-directed chips 21 to force a slight alteration in the direction of the chips in order for the chips to be expelled from the second exhaust port 38, as shown in FIG. 4B.

While preferred embodiments of the invention have been described, it should be understood by one skilled in the art that the invention is not so limited and modifications may be made without departing from the invention. The scope of the invention is defined by the appended claims, and all devices that come within the meaning of the claims, either literally or by equivalence, are intended to be embraced therein.

1. A bi-directional exhausting handheld planer comprising:
a housing having a first exhaust port and a second exhaust port;
a motor disposed within said housing;
a rotatable fan operatively connected to the motor;
a rotatable cutting tool operatively connected to the motor, wherein said cutting tool is disposed within a cutting chamber located within said housing, and said cutting tool is configured to remove a plurality of chips from a workpiece;
a pre-directing insert disposed within said cutting chamber; and
a selectively positionable flap configured to direct said chips toward one of said first exhaust port or said second exhaust port.

2. The bi-directional exhausting handheld planer of claim 1, wherein said flap is selectively positionable between a first position and a second position.

3. The bi-directional exhausting handheld planer of claim 2, wherein said chips are expelled from said first exhaust port when said flap is in said first position.

4. The bi-directional exhausting handheld planer of claim 2, wherein said chips are expelled from said second exhaust port when said flap is in said second position.

5. The bi-directional exhausting handheld planer of claim 2, wherein said pre-directing insert is configured to direct said chips toward one of said first exhaust port or said second exhaust port.

6. The bi-directional exhausting handheld planer of claim 1, wherein said insert includes a ribbed surface.

7. The bi-directional exhausting handheld planer of claim 6, wherein said ribbed surface has a plurality of raised ribs.

8. The bi-directional exhausting handheld planer of claim 7, wherein said raised ribs are oriented at an angle.

9. The bi-directional exhausting handheld planer of claim 8, wherein said raised ribs are oriented at an angle between about 15 degrees and 85 degrees from horizontal.

10. The bi-directional exhausting handheld planer of claim 8, wherein said raised ribs are oriented at about sixty-seven degrees from horizontal.

11. The bi-directional exhausting handheld planer of claim 8, wherein each of said raised ribs is connected by a sloped surface to an adjacent raised rib.

12. The bi-directional exhausting handheld planer of claim 11, wherein said ribbed surface is configured to pre-direct said chips toward said first exhaust port as said chips are removed from said workpiece and are directed toward a passageway connecting said first exhaust port and said second exhaust port.

13. The bi-directional exhausting handheld planer of claim 1, wherein said insert is made of acrylonitrile-butadiene styrene.

14. A method for planarizing a workpiece utilizing a bi-directional exhausting handheld planer comprising:
providing a housing having a first exhaust port and a second exhaust port;
providing a cutting chamber located within said housing;
rotatably mounting a cutting tool within said cutting chamber, wherein said cutting tool is configured to remove chips from said workpiece;
attaching a pre-directing insert to a surface of said cutting chamber;
providing a selectively positionable flap located within a passageway; and
selectively positioning said flap from a first position to a second position relative to said passageway wherein the direction of expulsion of said chips can be selectively determined.

15. The method of claim 14, wherein the cutting tool is configured to direct said chips toward said passageway connecting said first exhaust port and said second exhaust port.

16. The method of claim 14, wherein said passageway operatively connects said first exhaust port and said second exhaust port.

17. The method of claim 14, wherein said insert is configured to direct said chips toward either said first exhaust port or said second exhaust port.

18. The method of claim 17, wherein selectively positioning said flap in said first position causes said chips to be expelled from said first exhaust port.

19. The method of claim 17, wherein selectively positioning said flap in said second position causes said chips to be expelled from said second exhaust port.

20. The method of claim 17, wherein said insert includes a ribbed surface directed toward said cutting tool.

21. The method of claim 17, wherein said ribbed surface includes a plurality of raised ribs formed at an angle thereon.

22. A bi-directional exhausting handheld planer comprising:
a housing having a first exhaust port and a second exhaust port;
a motor disposed within said housing;
a rotatable fan operatively connected to the motor;
a rotatable cutting tool operatively connected to the motor, wherein said cutting tool is disposed within a cutting chamber located within said housing, and said cutting tool is configured to remove a plurality of chips from a workpiece;
a selectively positionable flap configured to direct said chips toward one of said first exhaust port or said second exhaust port; and
a means for directing the flow of said chips to one of said first or second exhaust ports, wherein said means for directing the flow of chips is located within said cutting chamber.
